(19) United States
(12) Patent Application Publication
(10) Pub. No.: US 2025/0014494 A1
(43) Pub. Date: Jan. 9, 2025

(54) Gray Level Control for Mitigating First Frame Rate Effects

(71) Applicant: Google LLC, Mountain View, CA (US)

(72) Inventors: Sangmoo Choi, Palo Alto, CA (US); Ka Ho Liu, San Diego, CA (US)

(73) Assignee: Google LLC, Mountain View, CA (US)

(21) Appl. No.: 18/884,496

(22) Filed: Sep. 13, 2024

Related U.S. Application Data
(60) Provisional application No. 63/691,033, filed on Sep. 5, 2024.

(51) Int. Cl. G09G 3/20; G04G 21/08

(52) U.S. Cl. CPC G09G 3/2007; G04G 21/08; G09G 2320/0261; G09G 2320/0613; G09G 2354/00

(57) ABSTRACT

This document describes systems and techniques for mitigating a display artifact that may result from first frame rate effects at low luminance levels. For example, in an implementation, a computer-implemented method includes receiving display data to be presented on a display of an electronic device at a display driver. At the display driver, a luminance level of the display data is determined. Responsive to determining at the display driver that the luminance level is below a threshold luminance level, a gray level is determined for one or more regions of the display data. Responsive to determining at the display driver that the gray level for at least one region of the one or more regions is below a baseline gray level for the threshold luminance level, the gray level is increased to an adjusted gray level equal to at least the baseline gray level.

### CROSS-REFERENCE TO RELATED APPLICATION(S)

This application claims the benefit of U.S. Provisional Patent Application Ser. No. 63/691,033, filed on Sep. 5, 2024, the disclosure of which is incorporated by reference herein in its entirety.

### BACKGROUND

Contemporary backlit displays offer very high resolution and a wide range of colors at seemingly ever-decreasing prices. These increasingly cost-effective displays make possible the proliferation of devices that use these displays, including mobile telephones, tablet computers and other flat panel displays, computer and television monitors, augmented reality (AR) goggles and glasses, virtual reality (VR) goggles and glasses, and wearable technology (e.g., smartwatches).

Organic light-emitting diode (OLED) displays include an array of individual diodes that provide an array of pixels in the display. OLED displays are highly popular for the quality of the images they present. However, one disadvantage that affects OLED displays is a low first frame rate at low luminance levels. As a result, when diodes illuminated at low luminance levels are changed from a low gray level to a higher gray level, it may take multiple refresh cycles during which one or more successive frames of display data are presented to the OLED display before the luminance of the diodes reaches the intended higher gray level. The presentation of the one or more successive frames that it takes for the luminance of the pixels to reach the intended higher gray levels may result in visual artifacts on the display that are noticeable to the user.

### SUMMARY

This document describes systems and techniques for mitigating a display artifact that may result from first frame rate effects at low luminance levels. In aspects, increasing a gray level from a level representing black or another very dark color to an adjusted, slightly higher gray level in one or more regions of the display may reduce first frame rate effects when the gray level is changed to a higher gray level. As a result, blurriness of one or more objects moving on the display or other display artifacts, may be mitigated, providing an improved user experience.

For example, in an implementation, a computer-implemented method includes receiving display data to be presented on a display of an electronic device at a display driver. At the display driver, a luminance level of the display data is determined. Responsive to determining at the display driver that the luminance level is below a threshold luminance level, a gray level is determined for one or more regions of the display data. Responsive to determining at the display driver that the gray level for at least one region of the one or more regions is below a baseline gray level for the threshold luminance level, the gray level is increased to an adjusted gray level equal to at least the baseline gray level to mitigate one or more artifacts appearing on the display as a result of first frame rate effects caused by the display data being below the baseline gray level for the threshold luminance level.

This Summary is provided to introduce systems and techniques for mitigating a display artifact that may result from first frame rate effects at low luminance levels, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques for mitigating a display artifact that may result from first frame rate effects at low luminance levels are described in this document with reference to the following Drawings. The same numbers are used throughout the drawings to reference like features and components.

FIG. 1 is a perspective diagram of an electronic device in the nature of a smartwatch configured to mitigate first frame rate effects at low luminance levels;

FIG. 2 is a graph representing first frame rate effects for a pixel for which a gray level is increased from lower gray levels to a higher gray level at a low luminance level;

FIG. 3 is a block diagram of an implementation of example electronic devices that are operable to adjust a gray level at low luminance levels to mitigate first frame rate effects;

FIG. 4 is a block diagram of the display driver of FIG. 3 working in concert with the display manager, the display, and the user input device to adjust a gray level of display data;

FIGS. 5A, 5B, 6A, and 6B are perspective diagrams of the smartwatch of FIG. 1 on which gray levels are adjusted to mitigate first frame rate effects;

FIGS. 7A and 7B are look-up tables that may be used in implementations to determine adjusted gray levels responsive to luminance levels to mitigate first frame rate effects;

FIGS. 8A, 8B, and 9A-9C are perspective diagrams of the smartwatch of FIG. 1 on which gray levels are adjusted responsive to movement or potential movement of objects on the display to mitigate first frame rate effects;

FIG. 10 is a perspective diagram of a user interface of the smartwatch of FIG. 1 including a gradient between an adjusted gray level in a region of a display and a gray level in one or more adjacent portions of the display;

FIGS. 11A and 11B are perspective diagrams of a monitor on which a gray level is adjusted to mitigate first frame rate effects; and

FIG. 12 is a flow diagram of an example method of adjusting a gray level to mitigate first frame rate effects.

### DETAILED DESCRIPTION

### Overview

On OLED displays or some other backlit displays, first frame rate effects may be exacerbated at low luminance levels when an initial gray level is set to a low level so as to appear to be black or nearly black. When the gray level is increased to a higher for a pixel at a low luminance level, particularly when the gray level is increased to a new gray level that is white or nearly white, multiple refresh cycles may pass and multiple successive frames of display data may be presented to the display before the pixel actually presents the higher gray level. As a result, when the appearance of moving objects on the display causes pixels to change from a very low gray level to a higher gray level, the objects of which those pixels are a part may appear to have blurred edges because of first frame rate effects. The blurred edges may not be satisfactory or pleasing to some users.

When a display is operating at a low luminance level, increasing a gray level of one or more regions of the display to an adjusted gray level that is equal to at least a baseline gray level to mitigate first frame rate issues may avoid blurred images or other visual artifacts that otherwise may result and, thus, may provide a more satisfactory or pleasing user experience.

### Sample Electronic Device with Increased Gray Level at Low Luminance Levels

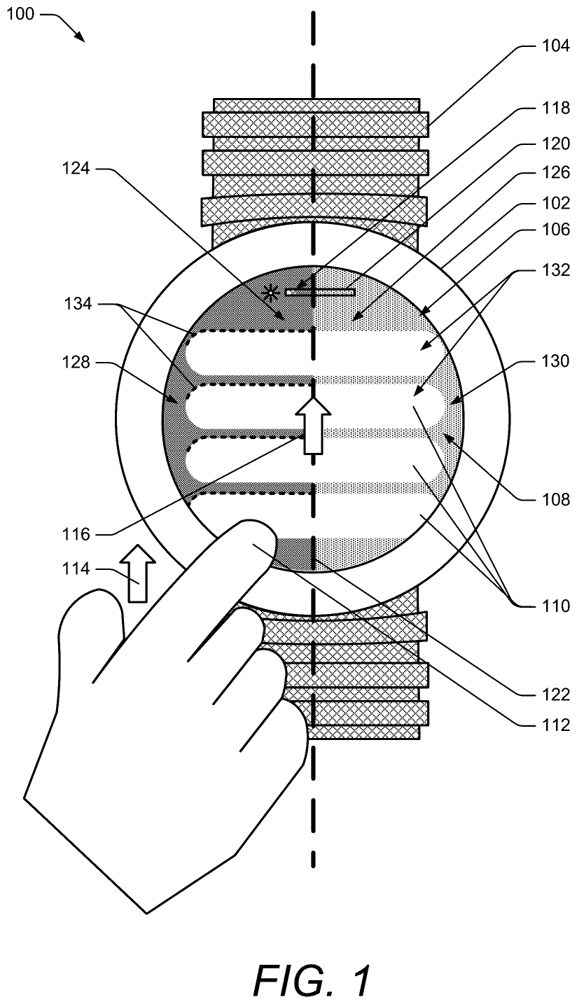

FIG. 1 shows a smartwatch 100 that includes an electronic device 102 that a user may wear on a band 104. The electronic device 102 includes a display 106 that presents a user interface 108 including one or more on-screen buttons 110. The buttons 110 represent options the user might select with a touch of a finger 112 or through which the user might scroll by moving the finger 112 across the display 106, for example, by moving the finger 112 upward in a direction 114 to cause the buttons 110 to move across the display 106 in a same direction 116. The display 106 is set to a low luminance level as represented by a low setting 118 of a brightness control 120 shown on the display 106. The smartwatch 100 is used as an example of how increasing gray levels at low luminance may be used to mitigate first frame issues, but the smartwatch 100 is only one example of how the systems and techniques described herein might be utilized.

More specifically, FIG. 1 illustrates a split-screen view of the display 106 bisected by a dashed line 122 into the first half 124 at left and a second half 126 at right. For sake of example, a first low gray level background 128 of the first half 124 is presumed to be below a threshold luminance level that will result in first frame rate effects becoming manifest when the gray level is substantially increased. A second low gray level background 130 of the second half 126 is at higher gray level that does not manifest the first frame rate effects when the gray level is substantially increased. In this example, the buttons 110 are of a high gray level 132 that present as white or nearly white.

In response to the finger 112 of the user moving in the direction 114, the buttons 110 move in the direction 116 which causes pixels at edges 134 of the buttons 110 to change from the low gray level backgrounds 128 and 130 of the respective halves 124 and 126 of the display 106 to the high gray level 132 of the buttons 110 as the buttons 110 move across those pixels. As a result, edges 134 of the buttons 110 in the first half 124 of the display 106 with the first low gray level background 128 may blur (as represented by the dashed lines 134 at edges of the buttons 110 in the first half 124 of the display 106) as a manifestation of the first frame rate issue resulting from the substantial increase in gray level from the first low gray level background 128 to the high gray level 132 of the buttons.

By contrast, because the second low gray level background 130 of the second half 126 of the display 106 is higher than the first low gray level background 128 of the first half 124 of the display 106, the movement of the buttons 110 and the corresponding increase in the gray level of pixels from the second low gray level 130 to the high gray level 132 of the buttons 110 does not result in first frame rate effects. Thus, the edges 134 of the buttons 110 in the second half 126 do not blur at all or do not blur to the same extent (and thus are not represented with the dashed lines 134). It will be appreciated that text, icons, or other symbols at a high gray level might also blur relative to a low gray level background when being moved. A small increase in the gray level of a background on which the text, icons, or other symbols at the high gray level are moving may similarly avoid blurring of the writing, icons, or other symbols at the high gray level. In any case, at low luminance levels below a threshold luminance level, a small increase from a low gray level to an adjusted gray level at or above a baseline gray level associated with the threshold luminance level may avoid blurring or other visual artifacts as a result of first frame rate effects caused by substantial increases from a low gray level to a high gray level.

### First Frame Rate Effects Depicted for Different Luminance Levels

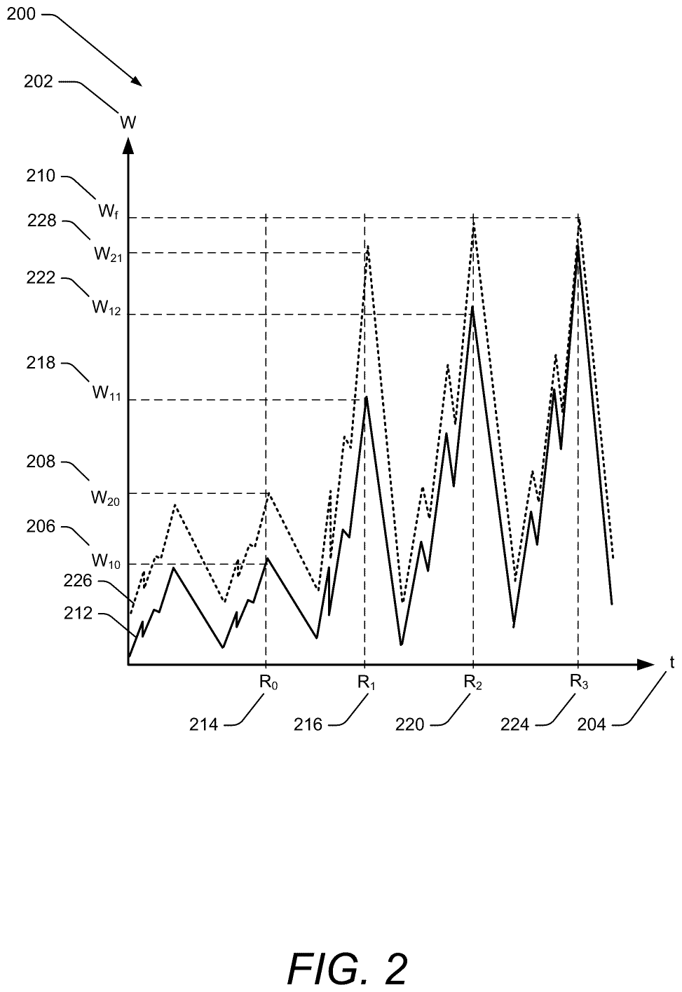

To illustrate how first frame rate effects at low luminance levels may cause blurriness or other visual artifacts, FIG. 2 is a graph 200 of gray level W 202 over time t 204 (measured in refresh cycles) at a low luminance level where the gray level W 202 is increased from different initial low gray levels W₁₀ 206 and W₂₀ 208 to a target, higher gray level 210. As in the example of FIG. 1, one might consider the graph 200 as representing gray levels of a pixel on a display that is changed from at a black or nearly black level to a white or nearly white level as a result of a light-colored object moving across a display over the pixel, thus causing the gray level of the pixel to be substantially increased.

In a first example, a plot 212 (represented as a solid line in FIG. 2) depicts an increase in gray level for a pixel with the initial low gray level of W₁₀ 206 through a start time at refresh cycle R₀ 214. At refresh cycle R₀ 214, a display driver or other circuitry (not shown) directs the pixel to a gray level W_{f} 210, which is a final, target gray level the pixel may assume after one or more cycles. The plot 212 shows that the gray level of the pixel does not reach the final gray level W_{f} 210 with a next refresh cycle R₁ 216 but only reaches W₁₁ 218, which is approximately one-half of the final gray level W_{f} 210. The plot 212 shows that the gray level of the pixel also does not reach the final gray level W_{f} 216 with a next refresh cycle R₂ 220, but only reaches W₁₂ 222, which is still only approximately three-quarters of the final gray level W_{f} 210. The plot 212 shows that it takes until refresh cycle R₃ 224 for the pixel to reach the final gray level W_{f} 210. Even at a refresh rate of many times per second, when a pixel requires multiple cycles to reach its target gray level, resulting blurriness of the image is noticeable and potentially unpleasant for a user of the device. Although not shown in FIG. 2, at low luminance levels, different-colored pixel elements not only may require multiple refresh cycles to may reach their target levels, but the differently-colored pixel elements may reach their target levels at different rates. Differently-colored pixel elements reaching their target levels at different times may exacerbate blurriness or other visual artifacts resulting from first frame rate effects.

By contrast, in a second example, a plot 226 (represented by a dotted line in FIG. 2) depicts an increase in gray level for a pixel with the initial low gray level of W₂₀ 208 through a start time at refresh cycle R₀ 214. At refresh cycle R₀ 214, a display driver or other circuitry (not shown) directs the pixel to the final, target gray level W_{f} 210, the same target level as in the example of the plot 212. The plot 226 shows that, by the next refresh cycle R₁ 216, the gray level of the pixel reaches W₂₁ 228, which is very close to the final gray level W_{f} 210. Thus, with a small increase in the initial low gray level of W₂₀ 208 as compared to the initial low gray level of W₁₀ 206, first frame rate effects are greatly reduced. The small increase in the initial low gray level of W₂₀ 208 over the initial low gray level of W₁₀ 206 may be inconspicuous or barely noticeable while, at the same time, mitigating first frame rate effects and causing any blurriness or other visual artifacts to be less noticeable.

Considering the plots 212 and 226 of FIG. 2 or similar data, for a selected display, a threshold luminance level may be determined for which a gray level below a baseline gray level will result in first frame rate effects causing blurriness or other visual artifacts to appear on a display. For example, if the luminance level at which the plots 212 and 226 are generated is regarded as a threshold luminance level, W₂₀ 208 may be regarded as a baseline gray level to which other gray levels should be adjusted at the threshold luminance level to mitigate first frame effects. At or below the threshold luminance level, changing the gray level of pixels at W₁₀ 206 or other gray levels below the baseline gray level of W₂₀ 208 to the adjusted gray level of W₂₀ 208 would avoid the multiple refresh cycles required to reach the final, target gray level W_{f} 210 and thus mitigate first frame rate effects causing blurriness or other visual artifacts to appear on the display.

### Example Devices Operable to Adjust Gray Levels at Low Luminance Levels

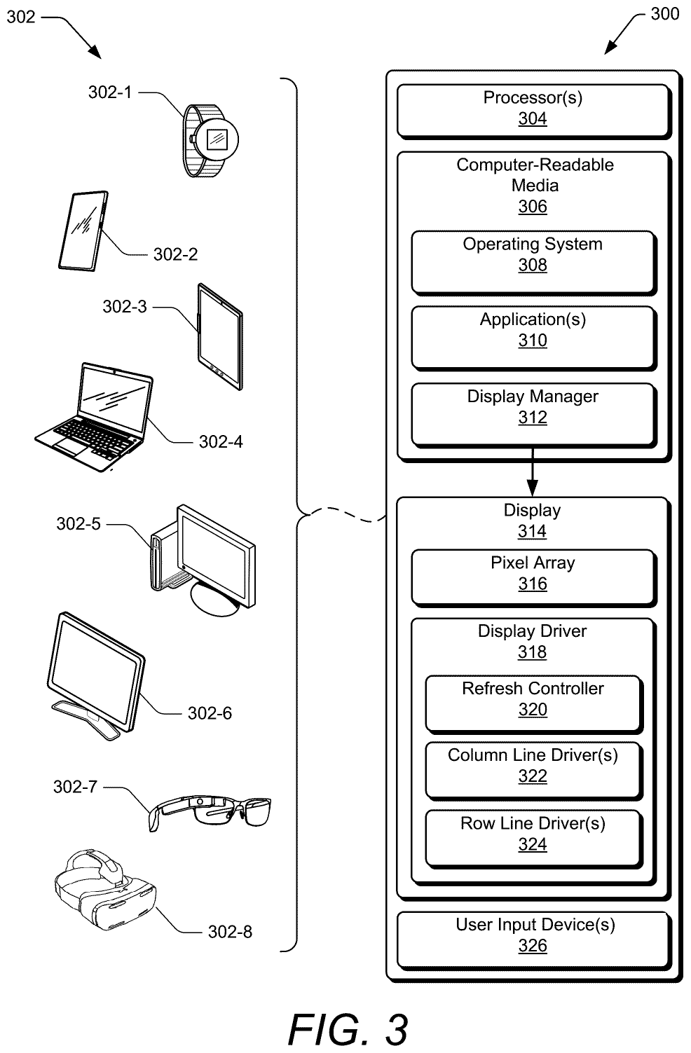

FIG. 3 is a block diagram of an example implementation 300 of example electronic devices 302 that are operable to adjust a gray level at low luminance levels to mitigate first frame rate effects. For example, the electronic devices 302 operable to adjust a gray level at low luminance levels may include a smartwatch 302-1 (similar to the smartwatch 100 of FIG. 1), a mobile telephone 302-2, a flat panel computing system 302-3 (e.g., a tablet computer or an automotive display), a portable computing system 302-4, a desktop computing system with an associated monitor 302-5, a video monitor 302-6 (e.g., a television or other video monitor), augmented reality (AR) glasses or goggles 302-7, and virtual reality (VR) glasses or goggles 302-8. It will be appreciated that the example electronic devices 302 are just that-examples of electronic devices that are operable to adjust a gray level at low luminance levels to mitigate first frame rate effects. Any other electronic device with a display may also be used with implementations herein described to adjust a gray level at low luminance levels to mitigate first frame rate effects.

As illustrated in FIG. 3, an electronic device 302 includes hardware and/or software components to control visual output. The electronic device 302 may be implemented in a system-on-chip (SOC) device or on one or more printed circuit boards (PCBs) or may otherwise be configured to support the functions described herein. In implementations, the electronic device 302 includes one or more processors 304 to process computer-executable instructions and respond to data that may be stored in computer-readable media 306. The computer-readable media 306 may include a combination of random-access memory (RAM), read-only memory (ROM), one-time programmable (OTP), memory, flash memory, or any other type of memory or storage device operable to maintain instructions and data. The instructions and data stored in the computer-readable media 306 may include an operating system 308, one or more applications 310, and a display manager 312 that is configured to generate display data (not expressly shown in FIG. 3) including visually-displayable text, symbols, and images. In the present example, the display manager 312 at least initially controls attributes of the display data, including luminance levels, gray levels, and/or other attributes of the display data generated by the display manager 312.

In aspects, the display data generated by the display manager 312 is presented to a display 314 that presents the display data to a user. The display may include a pixel array 316 that includes a number of pixels that, as described with reference to FIG. 2, are directed to generate light at various luminance levels, gray levels, or colors. A display driver 318 operably coupled with the pixel array 316 includes a refresh controller 320, one or more column line drivers 322, and one or more row line drivers 324 in communication with pixels in rows and columns of the pixel array 316 to cause each of the pixels to generate light at the various luminance levels, gray levels, and/or colors, and to periodically refresh the display 314 to present and display the display data received from the display manager 312.

The electronic device 302 also includes one or more user input devices 326. For example, a touch-sensitive display like the display 106 of the smartwatch 100 (see FIG. 1) may constitute a user input device 326 that allows a user, through the touch and/movement of the finger 112 (see FIG. 1) to interact with display data presented via the display 106. As described below, the display driver 318 may be responsive to the user input devices 326 to change a gray level on the display 314.

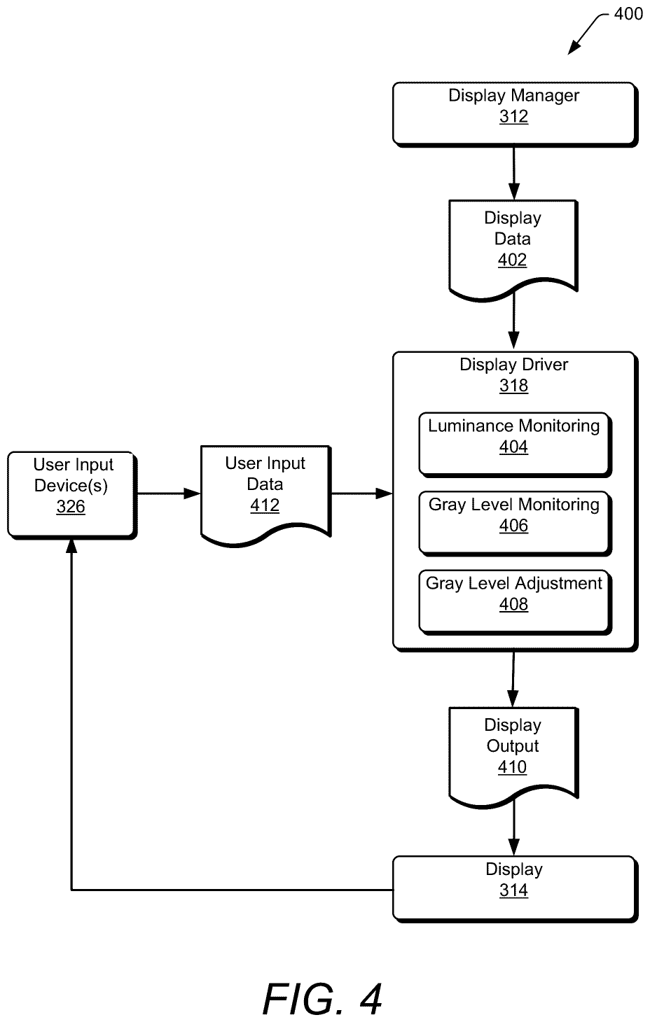

FIG. 4 shows a display control subsystem 400 including the display manager 312 that generates display data 402 that is received by the display driver 318, as described with reference to FIG. 3. The display driver 318 includes hardware-based or software-based components including a luminance monitoring component 404 and a gray level monitoring component 406 that determine the luminance level and the gray level of one or more regions of the display data 402, respectively. Responsive to the luminance monitoring component 404 determining that the luminance level is below a threshold luminance level, the gray level monitoring component 406 determines a gray level for one of more regions of the display data 402. Responsive to the gray level monitoring component 406 of the display data 402 determining that the gray level for at least one region of the one or more regions is below a baseline gray level for the threshold luminance level, the gray level adjustment component 408 increases the gray level to an adjusted gray level equal to at least the baseline gray level to mitigate one or more artifacts appearing on the display as a result of first frame rate effects caused by the display data being below the baseline gray level for the threshold luminance level. The display driver 318 thus generates display output 410 that mitigates first frame rate effects and presents the display output 410 to the display 314.

In addition, as further described below, the display driver 318 may adjust the display output 410 in response to user input data 412 received from the one or more user input devices 326. The one or more user input devices 326 may include a touch-sensitive display in the nature of the display 106 of the smartwatch 100 of FIG. 1, which is why the display 314 of FIG. 4 both receives the display output 410 and acts as a user input device 326 to provide user input data 412. As described further below, when the user input data 412 causes one or more objects to move in one or more regions of the display 314, the display driver 318 may engage the gray level adjustment component 408 to increase the gray level of the display output 410 presented on the display 314 to mitigate first frame rate effects on the display 314.

### Example Implementations of Increased Low Gray Levels

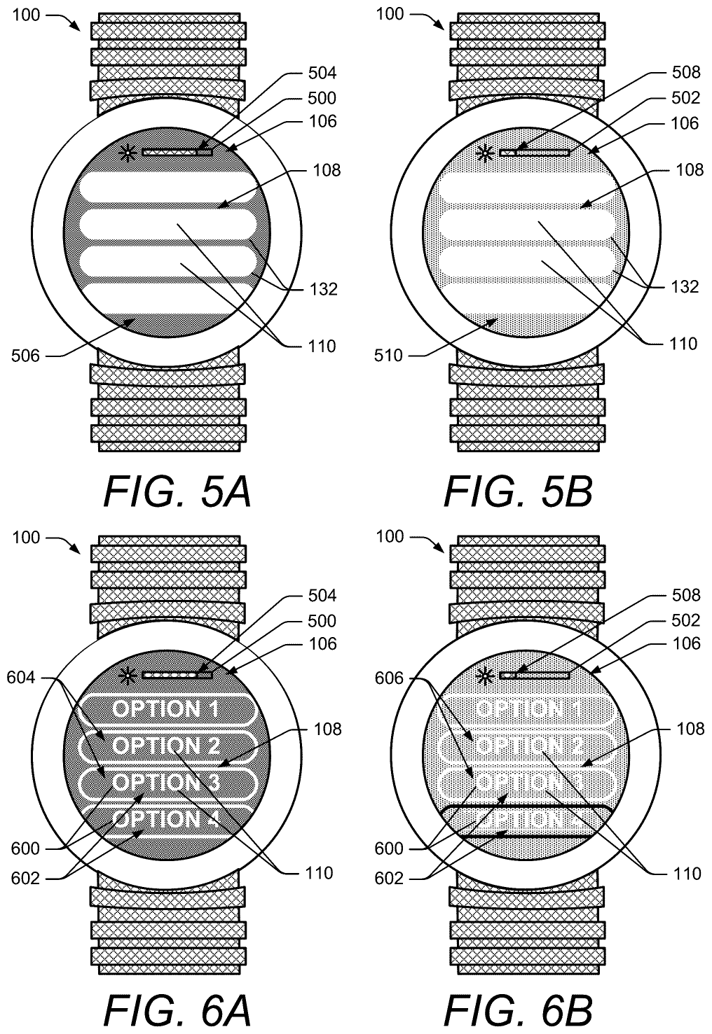

Adjusting a low gray level at low luminance levels to mitigate first frame rate effects may be implemented in many ways. FIGS. 5A and 5B show the smartwatch 100 of FIG. 1 at two different luminance levels as represented on the brightness controls 500 and 502 on the display 106 of the smartwatch 100. It will be appreciated that the brightness controls 500 and 502 may include manual brightness controls, settable by a user, and/or automatic brightness controls that adjust a luminance level of the display 106 in response to ambient light conditions sensed by a sensing circuitry (not shown) of the smartwatch 100. In aspects, the smartwatch 100 may be configured so that, at or below a threshold luminance level, one or more regions of the display 106 may be automatically increased by a set or proportional amount. In the example of FIG. 5A, the display 106 is at a relatively high luminance level 504 as indicated by the brightness control 500. Accordingly, in the example of FIG. 5A, it may not be necessary to increase a gray level of a background 506 of the display 106 to mitigate first frame rate effects.

By contrast, in the example of FIG. 5B, the display 106 is at a low luminance level as indicated by the low luminance level 508 indicated by the brightness control 502. Accordingly, as described in the example of FIG. 1, it may be desirable to increase the low gray level of a background 510 to prevent edges 134 of the buttons 110 or other objects from blurring as the buttons 110 or other objects are moved as described with reference to FIG. 1 as a result of first frame rate effects.

The regions of the display 106 for which the gray level is increased at low luminance levels may include other than the background 506 or 510 of the display 106. Referring to FIGS. 6A and 6B, the regions for which the gray level is increased at low luminance levels may include, for example, backgrounds of one or more text areas on the display 106. FIGS. 6A and 6B show the smartwatch 100 of FIG. 1 at the same two different luminance levels 504 and 508, respectively, as represented on the brightness controls 500 and 502, respectively, on the display 106 of the smartwatch 100. In the example of FIGS. 6A and 6B, words or symbols 600 are presented in text regions 602 on the buttons 110 of the user interface 108.

In the example of FIGS. 6A, because the luminance level 504 is not low, there may be no concern or little concern that movement of the words or symbols 600 over the text regions 602 will result in blurriness or other visual artifacts. Thus, a background 604 of the text regions 602 need not be increased from low gray level values to avoid blurriness or other visual artifacts as the words or symbols 600 move relative to the background 604 of the text regions 602. By contrast, in the example of FIG. 6B, because the luminance level 508 is low, a gray level of a background 606 of the text regions 602 is increased to mitigate first frame rate effects as the words or symbols 600 move relative to the background 606 of the text regions 602. Thus, in addition to or instead of changing a gray level of an overall background of the display 106 as described with reference to FIG. 1, the gray level of a background 604 or 606 of the text regions 602 or other regions of the display 106 may be changed at low luminance levels to mitigate first frame rate effects.

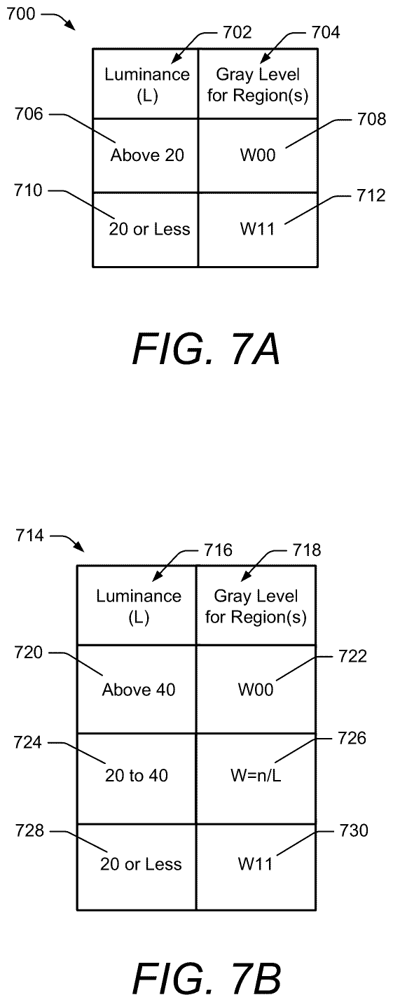

How gray levels may be adjusted in response to different luminance levels may be performed in different ways. In aspects, when a luminance level of the display data is below a threshold luminance level, a look-up table may be used to determine whether a gray level for one or more regions of the display data is below a baseline gray level for the threshold luminance level and to determine an adjusted gray level to which the gray level should be changed. Referring to FIG. 7A, one or more threshold luminance levels may be set that trigger increases in gray levels of backgrounds or other regions of the user interface. FIG. 7A includes a look-up table 700 that includes different threshold luminance levels 702 and associated adjusted gray levels 704 to which the gray level should be changed at the respective threshold luminance levels 702. In the look-up table 700, at a luminance level above 20 nits 706, the gray level 708 may be set to W00 710, the lowest gray level that presents as black. It will be appreciated that, at a luminance level above 20 nits 706, even the lowest gray level may not exhibit significant first frame rate effects, so there is no need to increase the gray level. On the other hand, at a threshold luminance level at or below 20 nits 710, first frame rate effects may be exhibited in the movement of objects across the display. Thus, the gray level 704 may be increased to an adjusted gray level of W11 712. As previously described, the gray level for one or more regions may include the background of the user interface, text regions, or other regions of the user interface.

Referring to FIG. 7B, however, the determination of adjusted gray levels need not be based on a binary or other lockstep change in luminance level. The look-up table 714 of FIG. 7B, like the look-up table 700 of FIG. 7A, includes different luminance levels 716 and associated adjusted gray levels 718 to be implemented at the respective luminance levels 716. In the look-up table 714, at a luminance level above 40 nits 720, the gray level 722 may be set to W00, the lowest gray level that presents as black. Instead of a lockstep change in a range between 20 nits and 40 nits 724, the adjusted gray level may be set according to a formula 726 based on the luminance level L. In the formula 726, the gray level W is inversely proportional (e.g., by a constant n) to the luminance level L. Accordingly, at relatively low values of the luminance level L within the range of 20 to 40nits 724, the value of W yielded by the formula 726 will be greater to significantly increase the gray level W at lower luminance levels within the range of 20 to 40 nits 724. On the other hand, at relatively high values of the luminance level L within the range of 20 to 40nits 724, the value of W yielded by the formula 726 will be lower to only slightly increase the gray level W at lower luminance levels L within the range of 20 to 40 nits 724. At threshold luminance levels of 20 nits or less 728, as in the look-up table 700 of FIG. 5A, the adjusted gray level 718 may be W11 730, a baseline level appropriate to mitigate first frame rate effects at low luminance levels of 20 nits or less 728. Thus, the gray level may be adjusted proportionately to luminance levels and/or the gray level may be set to fixed levels at empirically selected threshold luminance levels to mitigate first frame rate effects.

### Other Implementations of Increased Gray Levels at Low Luminance Levels

The foregoing examples have adjusted low gray levels based solely on luminance values and have adjusted the gray levels for the background across a user interface or in multiple regions across a user interface. However, the adjustment of gray levels may be based on other parameters and may be localized to affected areas of the user interface 108.

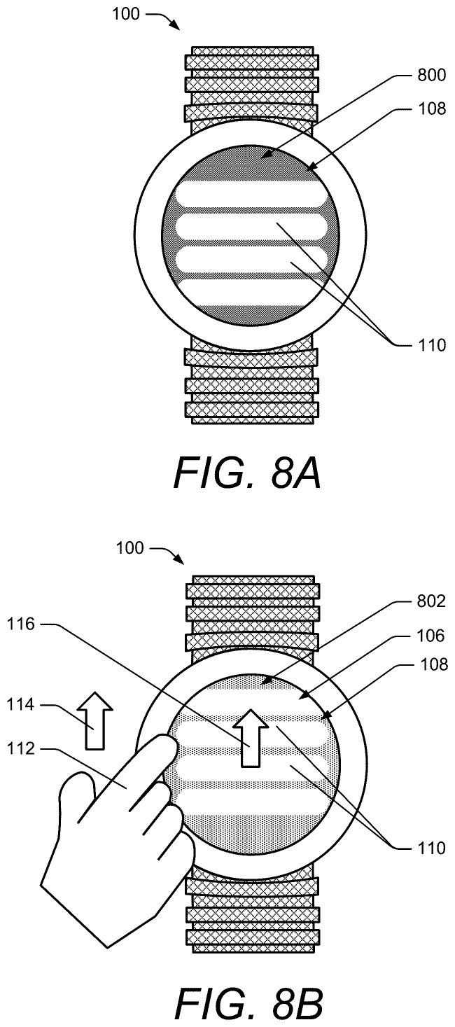

Referring to FIGS. 8A and 8B, a low gray level may be set based on low luminance levels and/or in response to movement of objects on the user interface 108. Continuing with the example of a smartwatch 100, when the user interface 108 is in a static condition (e.g., presenting no moving objects) as shown in FIG. 8A, first frame rate effects do not present a concern. When the user interface 108 is in a static condition, there are no edges 134 of buttons 110 to blur or other visual artifacts that may occur as a result of movement as described with reference to FIG. 1. Thus, even when a gray level 800 of the user interface 108 is very low, there may no need to increase the gray level 800 because there are no moving or changing objects to present first frame rate concerns.

However, as described with reference to FIG. 1, when there is movement of the buttons 110 in the direction 116 in response to movement of the finger 112 in a direction 114 across the display 106, the movement causes the first frame rate effects to manifest at 134 edges of the buttons 110, resulting in blurriness at the edges 134 of the buttons 110. Referring to FIG. 8B, responsive to detecting the movement of the buttons 110 or other objects or upon detecting responsive the touch of the finger 112 that may imminently cause the movement of the buttons in direction 116, an increased, adjusted gray level 802 may be applied in place of the initial gray level 800 of FIG. 8A. Thus, because first frame issues present a concern when movement on the display 106 occurs, increasing the low gray levels of one or more regions of the user interface 108 may be implemented responsive to detecting the movement or detecting an input that may initiate the movement.

In aspects, increasing the gray level of one or more regions to avoid first frame rate effects may be localized to areas that may be subject to first frame rate effects. Specifically, when a region of a user interface is moved or objects within one or more regions of a user interface are moved, a low gray level only needs to be changed in those regions to avoid first frame rate concerns.

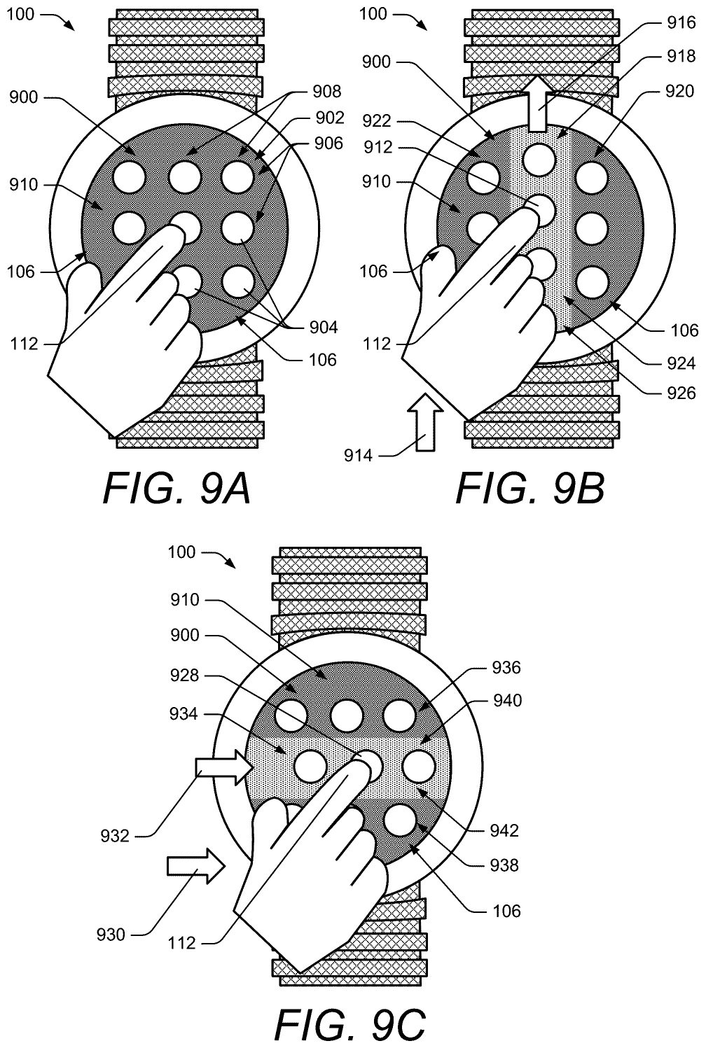

FIGS. 9A-9C show the display 106 of the smartwatch 100 presenting a user interface 900 including a two-dimensional array 902 of buttons 904 arrayed in rows 906 and columns 908. In FIG. 9A, the user interface 900 is static with none of the buttons 904 or any other objects moving. A display background 910 is set to a low gray level because, without movement of the buttons 904 or other objects, there are no first frame rate effects. Presence of the finger 112 indicates that a user may move one of the buttons 904, but the finger 112 may select one of the buttons 904 without moving it across the user interface 900, thus, there may be no need to increase the low gray level of the display background 910 to mitigate first frame rate effects.

FIG. 9B shows the finger 112 selecting a button 912 on the user interface 900 and moving the finger 112 in a direction 914 to cause the selected button 912 to move in a direction 916. In contrast to the examples of FIGS. 1 and 8B, however, because the buttons 904 are positioned in the two-dimensional array 902, the finger 112 causing the button 912 to move in the direction 916 indicates that a column 918 becomes a moving object without moving other columns 920 and 922. Responsive to the movement, a gray level of a region 924 around the column 918 is increased from the gray level of the display background 910 to an increased gray level 926 to mitigate first frame rate effects in the region 924 where the movement is taking place. With objects in the column 918 moving, applying an increased gray level 926 in the region 924 around the column 918 may be relatively inconspicuous while mitigating first frame rate effects that may manifest around column 918 as it moves. At the same time, the gray level of the remainder of the display background 910 may remain unchanged.

FIG. 9C shows the finger 112 selecting a button 928 on the user interface 900 and moving the finger 112 in a direction 930 to cause the selected button 928 to move in a direction 932. Moving the selected button 928 in the direction 932 causes a row 934 including the selected button 928 to become a moving object without movement of other rows 936 and 938. Responsive to the movement, the gray level of a region 940 around the row 934 is increased to a slightly higher gray level 942 to mitigate as blurriness or other artifacts caused by first frame rate effects in the region 940 where the movement is taking place. With objects in the row 934 moving, changing the gray level of the region 940 around the row 934 to the gray level 942 may be relatively inconspicuous while mitigating first frame rate effects in the region 940 around the row 934. At the same time, the gray level of the remainder of the display background 910 may remain unchanged. Thus, increasing a gray level to mitigate first frame issues may be localized to regions of the display 106 or the user interface 900 where movement is taking place without changing the gray level of other portions of the display 106 or the user interface 900 to minimize the appearance or conspicuousness of changing the gray level of portions of the display 106 or the user interface 900 to mitigate first frame effects.

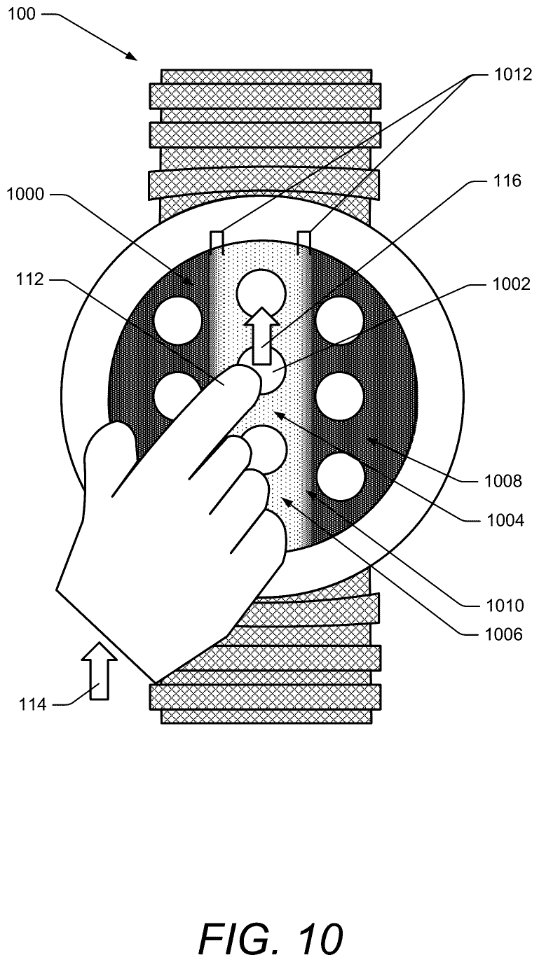

FIG. 10 illustrates a user interface 1000 in which, in response to a selection of a button 1002 by the finger 112 and movement of the finger 112 in the direction 114 resulting in movement of a region 1004 of the user interface 1000 in the direction 116. To mitigate first frame rate effects in the moving region 1004, a gray level of the region 1004 is increased to gray level 1006 from a gray level 1008 of a rest of the user interface 1000. To minimize conspicuousness of the changed gray level 1006 of the region 1004, a gradient 1010 is generated or applied to transition between the gray level 1008 of the rest of the user interface 1000 and the increased gray level 1006 of the region 1004. The gradient 1010 may be confined to edges 1012 of the region 1004 at or including an adjacent portion of the user interface 1000.

### Implementation of Increased Low Gray Levels in Other Devices

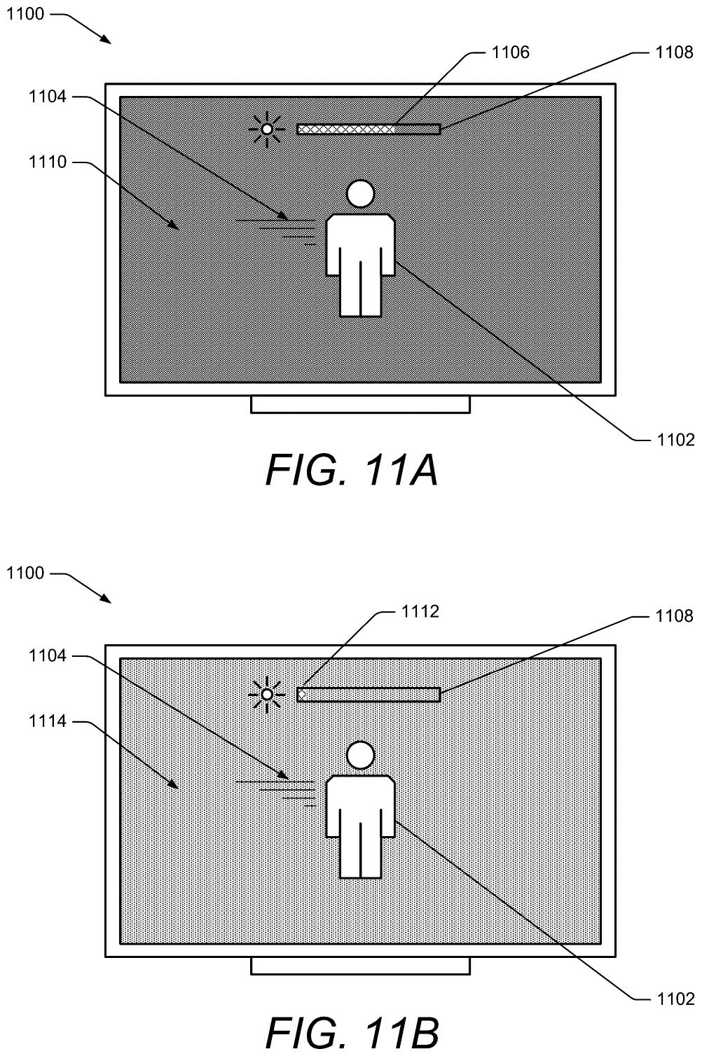

The foregoing examples have focused on the example of the smartwatch 100 that presents a user interface that a user may engage and manipulate with a finger 112 as previously described. However, increased gray levels at low luminance levels may be implemented in other devices that include a display to mitigate first frame rate effects regardless of whether the display includes a touchscreen display or is otherwise directly manipulated by a user. For example, FIGS. 11A and 11B show a monitor 1100 that may include a computer monitor, a video monitor, a television, or a similar device. The monitor 1100 may present images that includes a moving object 1102 (as represented by stacked lines 1104 in FIGS. 11A and 11B). In the example of FIG. 11A, the monitor 1100 is set to a medium to high luminance level 1106 as indicated on a brightness control 1108. Because the monitor 1100 is not set to a low luminance level, the moving object 1102 may not cause blurriness or other visual artifacts as a result of first frame rate effects despite a low gray level background 1110.

Referring to FIG. 11B, the monitor 1100 is set to a low luminance level 1112 as indicated on the brightness control 1108. As a result, to avoid first frame rate effects, the previous low gray level background 1110 is changed to a higher gray level background 1114 to mitigate first frame effects at the low luminance level 1112. As shown in the example of FIGS. 11A and 11B, implementations are not limited to devices like the smartwatch 100 of FIGS. 1, 5A-6B, 8A-8B, 9A-9C, and 10 in which user interaction causes the movement of objects on a display that result in first frame rate effects. Implementations may be used to mitigate first frame rate effects in video data viewed on the monitor 1100 of FIGS. 11A and 11B or on any devices 302 (FIG. 3) including a display.

### Example Method of Increasing Gray Levels to Mitigate First Frame Rate Effects

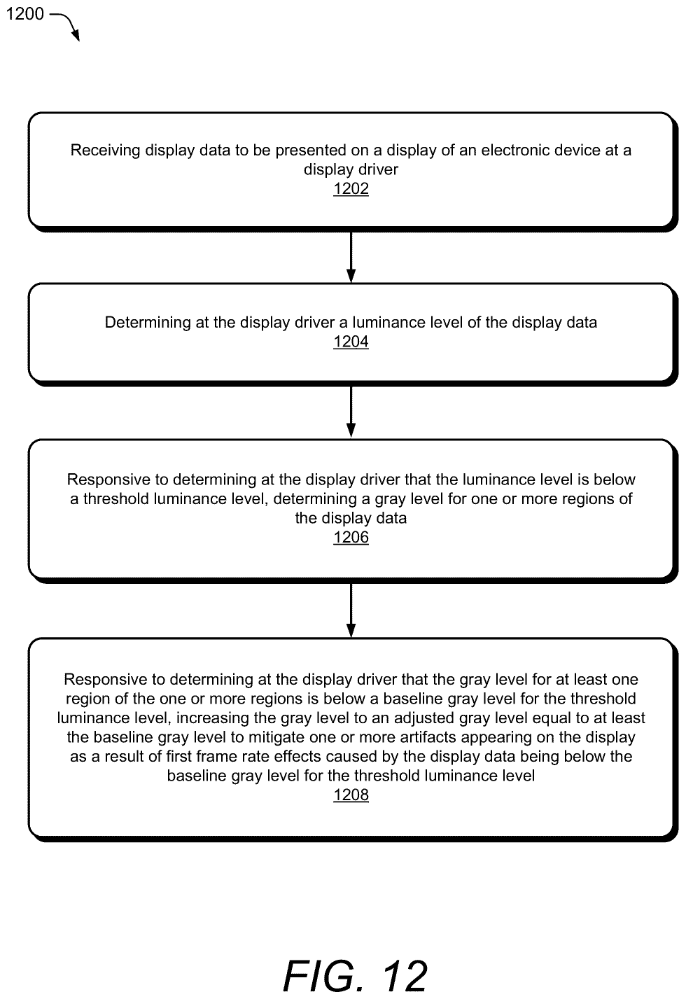

FIG. 12 illustrates an example method 1200 of increasing a gray level of one or more regions of a display to mitigate first frame rate effects. At a block 1202, display data to be presented on a display of an electronic device is received at a display driver, as described with reference to FIGS. 3 and 4. At a block 1204, a luminance level of the display data is determined at the display driver, as also previously described with reference to FIG. 4. At a block 1206, responsive to determining at the display driver that the luminance level is below a threshold luminance level, a gray level is determined for one or more regions of the display data, as described with reference to FIGS. 5A-6B. At a block 1208, responsive to determining at the display driver that the gray level for at least one region of the one or more regions is below a baseline gray level for the threshold luminance level, the gray level is increased to an adjusted gray level equal to at least the baseline gray level to mitigate one or more artifacts appearing on the display as a result of first frame rate effects caused by the display data being below the baseline gray level for the threshold luminance level, as described with reference to FIGS. 7A and 7B.

This document describes systems and techniques for mitigating a display artifact that may result from first frame rate effects at low luminance levels. Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### Conclusion

Although implementations of systems and techniques for mitigating a display artifact that may result from first frame rate effects at low luminance levels have been described in language specific to certain features and/or methods, the subject of the appended claims is not necessarily limited to the specific features or methods described. Rather, the specific features and methods are disclosed as example implementations of systems and techniques for mitigating a display artifact that may result from first frame rate effects at low luminance levels.

What is claimed is:

1. A computer-implemented method comprising:
receiving display data to be presented on a display of an electronic device at a display driver;
determining at the display driver a luminance level of the display data;
responsive to determining at the display driver that the luminance level is below a threshold luminance level, determining a gray level for one or more regions of the display data; and
responsive to determining at the display driver that the gray level for at least one region of the one or more regions is below a baseline gray level for the threshold luminance level, increasing the gray level to an adjusted gray level equal to at least the baseline gray level to mitigate one or more artifacts appearing on the display as a result of first frame rate effects caused by the display data being below the baseline gray level for the threshold luminance level.

2. The computer-implemented method of claim 1, wherein the one or more regions of the display data comprise at least one of a background of a user interface or a background of a text area on the display included.

3. The computer-implemented method of claim 1, wherein the adjusted gray level is determined according to a look-up table associating a plurality of output gray levels with a plurality of luminance levels.

4. The computer-implemented method of claim 1, wherein the adjusted gray level is determined according to a formula that increases the adjusted gray level in inverse proportion to the luminance level.

5. The computer-implemented method of claim 1, further comprising:
determining at the display driver that the display data includes one or more moving objects in the at least one region of the display data; and
increasing the gray level to the adjusted gray level in the at least one region of the display data.

6. The computer-implemented method of claim 1, further comprising:
detecting at a user input device a user input operable to cause one or more one or more moving objects to be included in the at least one region of the display data; and
responsive to detecting the user input, increasing the gray level to the adjusted gray level in the at least one region of the display data.

7. The computer-implemented method of claim 1, further comprising in response to the at least one region being presented with a gradient between the adjusted gray level and one or more additional regions adjacent to the at least one region.

8. The computer-implemented method of claim 1, wherein the display artifact comprises a perceivable blurriness of one or more objects moving on the display in the one or more regions of the display.

9. The computer-implemented method of claim 1, wherein the electronic device includes one of:
a smartwatch;
a monitor;
a television;
a mobile telephone;
a flat panel interface;
a tablet computer;
a desktop computer;
augmented reality glasses or goggles; and
virtual reality glasses or goggles.
